(19) United States
(12) Patent Application Publication
(10) Pub. No.: US 2002/0110658 A1
(43) Pub. Date: Aug. 15, 2002

(54) Composite tank and method for preparing same

(76) Inventors: Robert V. Lucke, Cincinnati, OH (US); Arthur K. Delusky, Detroit, MI (US); Thomas M. Ellison, Fort Mill, SC (US); Stephen P. McCarthy, Tyngsboro, MA (US)

Correspondence Address: Robert H. Bachman, BACHMAN & LaPOINTE, P.C., Suite 1201, 900 Chapel Street, New Haven, CT, 06510-2802, US

(21) Appl. No.: 10/056,374

(22) Filed: Jan. 23, 2002

Related U.S. Application Data
(60) Provisional application No. 60/268,161, filed on Feb. 12, 2001.

(51) Int. Cl. B29C 43/02; B32B 1/02

(52) U.S. Cl. 428/35.7; 264/320

(57) ABSTRACT

The compression molded fuel tank includes a first and second section, each of which is a laminate of at least two dissimilar materials. The sections are affixed together at peripheral portions thereof to form a closed, hollow member with an internal cavity therein, and including an inlet to the internal cavity. The laminate of each section is a compression molded laminate and includes an outer plastic film layer and an inner plastic layer.

### CROSS-REFERENCE TO RELATED APPLICATION

This application claims the benefit of U.S. Provisional Application S No. 60/268,161, filed Feb. 12, 2001.

### BACKGROUND OF THE INVENTION

The present invention relates to an improved composite tank and method for preparing same, particularly a fuel tank as for automobiles or other fuel storage tanks.

Metal tanks made to contain fuels or other vaporous liquids, as for automobiles, trucks and other applications, are heavy and difficult to shape for best space efficiency, especially for small cars. Further, metal fuel tanks are at risk for explosion under certain crash conditions due to vapor build up in the rigid tank. Toyota reports the use of a multi-layer polyolefin/polyamide bladder inside a steel tank to minimize vapor build up in an empty tank, see SAE Technical Paper 2001-01-1120. In recent years all plastic fuel tanks have been made by blow molding and thick sheet thermoforming. As reported in Plastics Engineering (December 2000 p. 42), Volkswagen uses a five layer-high density polyethylene (HDPE), adhesive, nylon, adhesive, HDPE construction to make blow molded fuel tanks for certain vehicles. The blow molding process, while efficient, is limited for placement of inserts and devices such as fuel gauges and pumps, inside the blow molded tank. Access holes must be cut into the tank wall for placement of these inserts, thus increasing the points for vapor emission. This limitation can be overcome by thermoforming two plastic sheets into tank halves, placing the inserts in one half and bonding the two halves together. Kiefel Technologies, Hampton, NH, reports the use of a thermoformed five layer sheet—HDPE, adhesive, ethylvinyl alcohol (EVOH), adhesive, HDPE—to make a fuel tank in a plug assist thermoforming process, see Modern Plastics, April 2000 p. 10. The resulting tank is reported to reduce weight by 30% to 40%. In the thermoforming process, a sheet of plastic is first made as by extrusion or multi-layer extrusion. The extruded sheet represents an inventory item that requires material handling for the next step. The sheet is then reheated to a flowable state for thermoforming. This heat cycle consumes energy and contributes to possible polymer degradation.

Plastic tanks, in general, have a safety advantage over the metal tanks they replace. In the event of a fire, a plastic tank melts and releases fuel, but it does not explode, as would a steel tank. Even so plastic tanks are more subject to puncture. What is needed is a plastic tank with improved puncture resistance and with improved production efficiency over state of the art plastic tanks.

U.S. Pat. No. 6,132,669 for PROCESS FOR PREPARING A MOLDED ARTICLE, By Emery I. Valyi (deceased), Arthur K. Delusky, Thomas M. Ellison and Herbert Rees, Patented Oct. 17, 2000, teaches the preparation of a molded article by placing a film over a mold cavity, depositing molten plastic thereon to form a combination of a film with molten plastic thereon, and forming the film-molten plastic combination in the mold cavity into a compression molded article in the shape of the mold cavity.

It would be highly desirable to prepare a composite fuel tank as aforesaid using a film-molten plastic combination, which tank overcomes prior difficulties.

It is, therefore, a principal object of the present invention to provide a composite fuel tank and method for obtaining same.

It is a further object of the present invention to provide a tank as aforesaid which is simple and easily prepared and which is highly advantageous.

Further objects and advantages of the present invention will appear hereinbelow.

### SUMMARY OF THE INVENTION

In accordance with the present invention, the foregoing objects and advantages are readily obtained.

The compression molded fuel tank of the present invention comprises: a first and second section, each of which is a laminate of at least two dissimilar materials, wherein said sections are affixed together at peripheral portions thereof to form a closed, hollow member with an internal cavity therein, and including an inlet to said cavity; wherein the laminate of each section includes an outer plastic film layer and an inner plastic layer, and wherein each laminate is compression molded.

The method for forming a compression molded fuel tank of the present invention comprises: compression molding first and second laminates for first and second sections of said fuel tank, each having at least two dissimilar materials, wherein the laminate of each section includes an outer plastic film layer and an inner plastic layer; affixing said sections together at peripheral portions thereof to form a closed hollow member with an internal cavity therein; and forming an inlet to said internal cavity.

The inlet may be forward either before or after the sections are affixed together.

In accordance with the present invention, a plastic film, as for example a composite film, is placed on a mold cavity. The surface facing the cavity, which will be the outer surface of the final molded tank, may be designed to dissipate electrical charge or sparking. Additionally it may be designed to add strength, fire retardancy and/or additional barrier properties to the finished tank. Its composition may be fibrous and/or a polymer film layer having fillers therein such as glass fibers, carbon fibers, synthetic polymer fibers, natural fibers and/or fire retardant additives.

The surface of the film or composite film facing away from the cavity is designed to bond to a deposited molding resin and may also contribute to tank strength and barrier properties.

Molding resin is distributed over the film surface by any melt delivery means, such as, for example, those shown in the aforesaid U.S. Pat. No. 6,132,669. The deposited molten resin bonds either by melt bonding to the surfacing film, chemically as to an adhesive or mechanically as to a surface mat. The heat from the molten resin conditions the film or composite film for forming. The molding resin is selected for its properties, which make it suitable for a fuel tank such as strength, toughness, barrier properties, etc.

Thus, in accordance with the present invention a two part plastic fuel tank is provided. The present tank may desirably have barrier layers to meet the vapor emission requirements and optional reinforcement for superior toughness. Multiple barrier layers of different barrier properties may be incorporated in the tank wall construction to prevent release of a variety of vapors such as for example, ethanol and aromatic components of gasoline. The tank is made in two parts for ease of placement of inserts without need for additional openings in the tank wall. Baffles, to minimize fluid flow and “sloshing” may optionally be molded into either or both halves. The two halves may be molded with rolled edges so that the outer film of each half can be bonded at the seam. Alternatively, the halves can be molded with a flange allowing the two inner surfaces to be bonded in final assembly. As a further alternative, the two halves may be molded or machined with an interference fit for kinetic welding as described in U.S. Pat. No. 4,997,500.

Further features and advantages of the present invention will appear hereinbelow.

### BRIEF DESCRIPTION OF THE DRAWINGS

The present invention will be more readily understood from a consideration of the accompanying drawings, wherein:

FIG. 1 is a partly schematic view of the method of the present invention in an early stage of the preparation of the fuel tank of the present invention;

FIG. 2 is a perspective view of the fuel tank of the present invention;

FIG. 3 is a sectional view of one embodiment of the fuel tank of the present invention, including a bonding area at a peripheral flange;

FIG. 4 is a sectional view of a further embodiment of the fuel tank of the present invention, including a bonding area at an internal flange;

FIG. 5 is a partial sectional view showing a further embodiment for connecting the fuel tank sections;

FIG. 6 is a sectional view of a further embodiment showing both fuel tank sections prepared in a single step;

FIG. 7 is a schematic top view of a further embodiment similar to FIG. 6 showing molded-in components; and

FIGS. 8-13 are partial sectional views showing various embodiments of the layered wall structure of the fuel tank of the present invention.

### DETAILED DESCRIPTION OF PREFERRED EMBODIMENTS

In accordance with the present invention, a plastic film or composite film is placed over a mold cavity, plastic material is deposited thereon, and the assembly compression molded to form a fuel tank section. A second fuel tank section similarly compression molded, is affixed to the first compression molded section at peripheral portions thereof. This forms a closed hollow member having an internal cavity therein, which is the fuel tank of the present invention. An inlet to the internal cavity is formed either before the sections are affixed together or after the sections are affixed together.

A wide variety of films and molding resins can be used to meet the desired mechanical and barrier properties. These include, but are not limited to, polyolefins, polyamides, ethylvinyl alcohol (EVOH), fluoropolymers, polyesters and copolymers or blends thereof. Tie layers or adhesives may be used to bond certain layers to each other. The initial film or composite film placed on the mold cavity may be an extruded layer or a film rolled onto or applied onto the mold cavity. One or more layers in the composite construction may be made conductive by the incorporation therein of conductive additions in order to reduce or eliminate static electricity build-up and possible sparking in the tank structure. This can be readily done and represents a considerable advantage. Similarly, one or more layers may contain nano-composite clay particles or other fillers that improve barrier properties. Thin metal layers may be applied by vacuum deposition or sputtering to one or more film surfaces to add improved barrier properties. The barrier properties of these coatings may be reduced due to cracks in the coating as the films are stretched, but if so will still maintain significant barrier capability.

A particularly interesting metal coating that may be used is a discontinuous, vapor deposited indium as described in U.S. Pat. No. 6,287,672. This coating can be formed extensively while maintaining a uniform distribution of metal over the film surface.

In addition, reinforcing materials may be used in the tank wall construction to improve strength and overall toughness. The reinforcing material may be in the form of fiber fillers in the molding resin (not practical for blow molding or thermoforming) or woven or non-woven fibers in the form of veils or mats. The veils or mats may be placed on the molding resin before the mold is closed to form the compression molded laminate.

Thus, the structural reinforcing layer may contain natural or synthetic polymer fibers to include high density polyethylene, carbon fibers, metal fibers, glass fibers or any combination of two or more fibers. These may, for example, be placed on the molten resin and a second molten resin of the same polymer as the first, or a different polymer may be deposited thereover.

Other materials, such as those described in the aforesaid U.S. Pat. No. 6,132,669, may also be used in the tank construction.

Films used in the tank construction of the present invention may be made by the blown film process, solvent casting, or by flat die extrusion, or by other means used in the art to make mono-layer and multi-layer films. In general, thickness for each film will range from about 0.010″ to about 0.050″. It should be noted that films above 0.010″ in thickness are usually referred to as sheets in industry. However, the term “film” is used in the present invention to define a material having a large two dimensional surface area relative to its “Z” direction thickness without regard to a particular limiting thickness. The molding resin will generally range from about 0.050″ to about 0.40″ in thickness for each molding resin layer.

The fuel tank halves are formed by depositing a molten resin over a film that may be attached to a mold cavity or held in a frame and subsequently transported to the mold cavity. The resin may be a mono-layer, a co-extruded multi-layer, or a sequentially deposited multi-layer. Multi-layer molding resins may include tie layers to bond dissimilar resin layers together in the molding resin deposit. The deposited molten resin bonds to the film and heats the film for forming. The mold core is then closed to form the fuel tank section by compression molding.

A barrier membrane, which may be a composite film, may desirably be placed on the last resin deposited. One side of the membrane laminate may be designed to bond to the deposited molding resin and accordingly is placed with that side toward the molding resin. The top layer may be designed to be a primary barrier to loss of fuels and/or vapors stored in the tank. The selection of this layer will depend on the fuel to be stored among other things. Representative barrier layers include polyvinyl difluoride, polyvinyl fluoride, tetrafluoroethylene, nylon, polyvinyl alcohol, acrylonitrile and other similar polymers, copolymers or blends of these or other materials that have excellent fuel barrier properties.

After forming, inserts such as fuel gage components, valves, sensors, fuel pumps, etc. are desirably attached inside one or the other molded sections, and the two halves are bonded together. Baffles and certain inserts may be placed in the mold core prior to forming and bonded to a mold half as the mold is closed. In another alternative, once the mold is closed, sliders, gates and manifold runners in the core or cavity may be used to inject attachments such as a filler connection, bosses, baffles or other features. The injected polymer or molding resin is desirably selected to form a good bond to a fuel tank wall layer adjacent the mold surface.

The two compression molded tank halves are then bonded together at a mating edge or flange. Bonding may be accomplished by any suitable means used in the plastics industry to bond two plastic parts together. Thus, bonding may be achieved by various heating means to achieve a melt bond or by the use of adhesives. If an edge flange is used as for providing a bonding site, it may also be drilled to provide attachment points for mounting the tank to a vehicle.

The resultant article and the method for preparing same achieves considerable advantages. A multi-layer or composite tank is readily obtained with significant advantages over those obtained heretofore. Moreover, the present invention enables the incorporation of various functional layers in one molding step, as well as the ability to integrate connections to the tank in the molding process or by efficient post mold operations. Still further, the process and article of the present invention is relatively low cost and has significant commercial value.

Referring to the drawings, FIG. 1 shows a mold 10 consisting of a female mold or cavity half 12 with mold cavity 12a therein and core half 14 mounted on respective platens 16 and 18. Mold cavity 12a has a shape of the desired molded article, in this case one section of the fuel tank. At least one of the cavity half and core half is reciprocable in the direction of arrow 20 from an open to a closed position and from a closed to open position.

An extruder/injection unit 22 having a nozzle 24 is arranged adjacent mold 10 to coact with a so-called coat hanger die 26, which serves as a hot plastic delivery plate.

A hold down and spacer frame 28 is aligned with cavity half 12 and holds plastic film 30 over cavity half 12. The frame 28 is engageable with and detachable from cavity half 12 and is coupled with means to move same (not shown) towards and away from cavity half 12 independently of the reciprocal movement of core half 14. Thus, a pair of lift cylinders 32 may be mounted on either platens 16 or 18, with mounting on platen 16 being shown in FIG. 1.

Thus, in accordance with the embodiment of FIG. 1, die 26 serves as a hot plastic delivery plate, depositing plastic 34 via slit opening 36 on the entire upper surface of film 30. The extruder 22 and die 26 are reciprocable in the direction of arrow 38 towards and away from mold 10. In operation, the blank or film 30 having been placed over the mold cavity 12a and clamped down as by spacer frame 28, the extruder 22 and die 26 are traversed over blank 30 and the desired layer of hot plastic 34 is deposited thereover. The thickness of the plastic layer is given by the speed of traverse, the output of the extruder and the dimensions of the die, all controlled in a conventional manner. At the end of the traverse, the extruder is shut off and returned to its starting position. One may provide an extruder with width and/or thickness control to control the thickness and/or width of the plastic layer. The speed of traverse and/or the output of the extruder could be variable. The positioning of the extruder in the X, Y and Z planes could be variable to vary the dimensions and/or configuration of the plastic layer.

If desired, fluid pressure may be applied to mold cavity 12a under blank 30, as through channels 40 connected through a joint manifold 42 with pressure control means 44. The fluid usually used is air, but may also be an inert gas if the material of blank 30 so requires. Alternatively, fluid pressure may be applied through channel 46 in cavity half 12 directly beneath film blank or film 30 in order to properly hold the film in place. Preferably, a plurality of locations, or a continuous channel, are provided around the circumference of the film directly beneath the film. Also, these may be valved separately from channels 46 or used instead of channels 40.

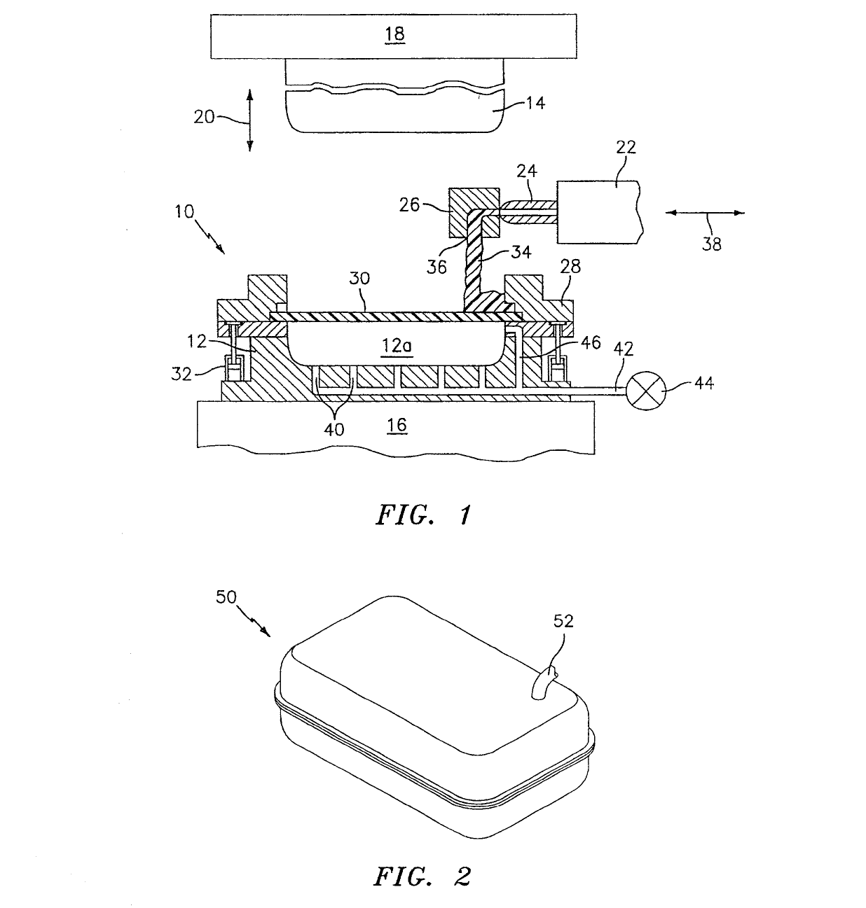

After deposition of hot plastic 34 on film 30, the extruder 22 and die 26 are moved away from between core 14 and cavity half 12. The resultant laminate of film 30 and deposited plastic 34 is then compression molded by interaction of core 14 and cavity half 12 to form the resultant compression molded fuel tank section. This represents one section of the fuel tank. A second section of the fuel tank is then prepared and the two sections assembled together to form the fuel tank 50 as shown in FIG. 2.

The embodiment of FIG. 1 is representative only and a wide variety of alternate procedures may be utilized to form the compression molded fuel tank halves. For example, those procedures described in U.S. Pat. No. 6,132,669 may be readily employed. Alternatively, the laminate of film 30 and plastic 34 may be formed at a separate location and brought to mold 10 after assembling the film and plastic. As a further alternative, a preformed plastic sheet may be used instead of a deposited hot plastic as shown in FIG. 1. If this procedure is employed, the laminate or assembly is desirably heated prior to compression molding.

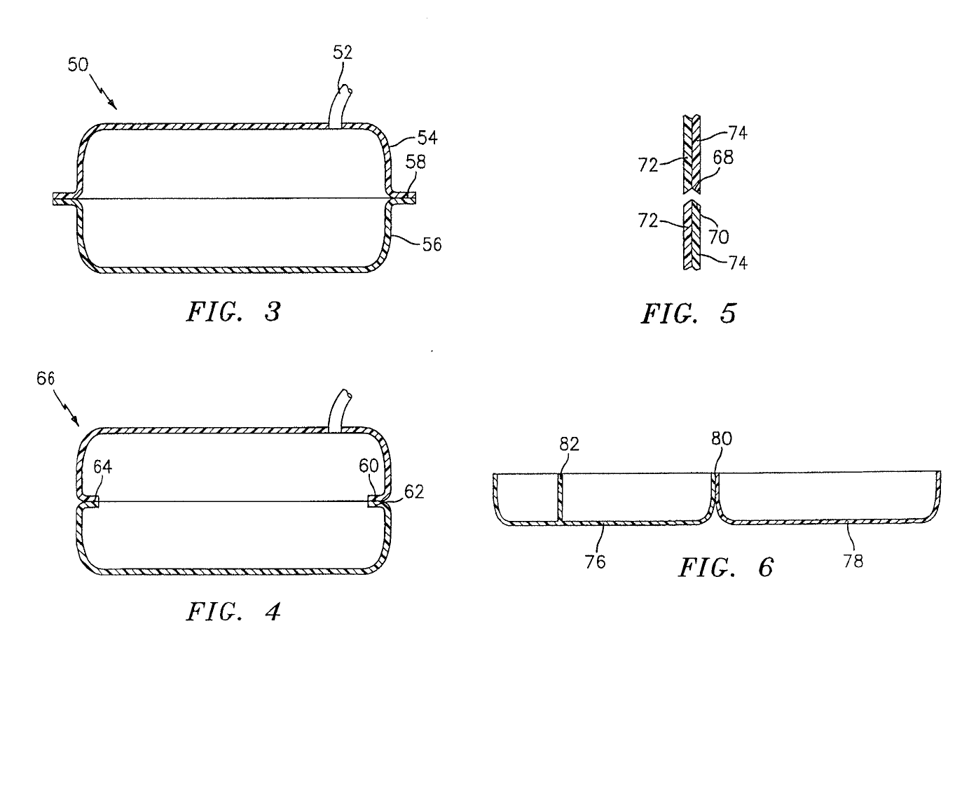

If desired, the deposited resin may be a mono-layer as shown in FIG. 1, a co-extruded multi-layer or a sequentially deposited multi-layer. Multi-layer molding resins may include tie layers or adhesive layers to bond dissimilar resin layers together in the molding resin deposit. The deposited molten resin would bond to the film and heat the film for forming. After the part is formed, any desired inserts or other components may be attached inside one or both mold halves and the mold halves bonded together as shown in FIG. 2 to form the fuel tank of the present invention. Inlet 52 is provided to the internal cavity of the fuel tank. Desirably, the fuel tank sections 54, 56 are adhered together along a peripheral flange 58. This may be done by welding or adhesives and/or separate connecting members. This is clearly shown in FIG. 3. As a further embodiment shown in FIG. 4, edge portions of each section 60, 62 are turned inwardly to form an inwardly directed flange 64. The inwardly directed flange is then bonded together as by any of the aforesaid methods to form a bonded fuel tank 66 as shown in FIG. 4.

As a further alternative shown in FIG. 5, the edge portions of each section may be shaped to form shaped portions 68, 70, which are then engaged together and welded as by kinetic welding. As shown in FIG. 5, layer 72 represents the film layer, and layer 74 represents the deposited resin layer. As a further alternative shown in FIG. 6, the two fuel tank sections 76, 78 may be formed in a single step using two adjacent mold cavities. If desired, the two halves 76, 78 may be joined together by plastic hinge 80, resulting in reduction of the necessary sealing to the remaining three edges. If desired, a baffle 82 may be bonded to one or both sections after compression molding. The baffles may be made of the same polymer as the innermost wall surface, or of a different material.

It is, of course, appreciated that the depictions in FIGS. 3, 4 and 6 are partly schematic and each of the mold sections is a laminate similar to the depiction of FIG. 5.

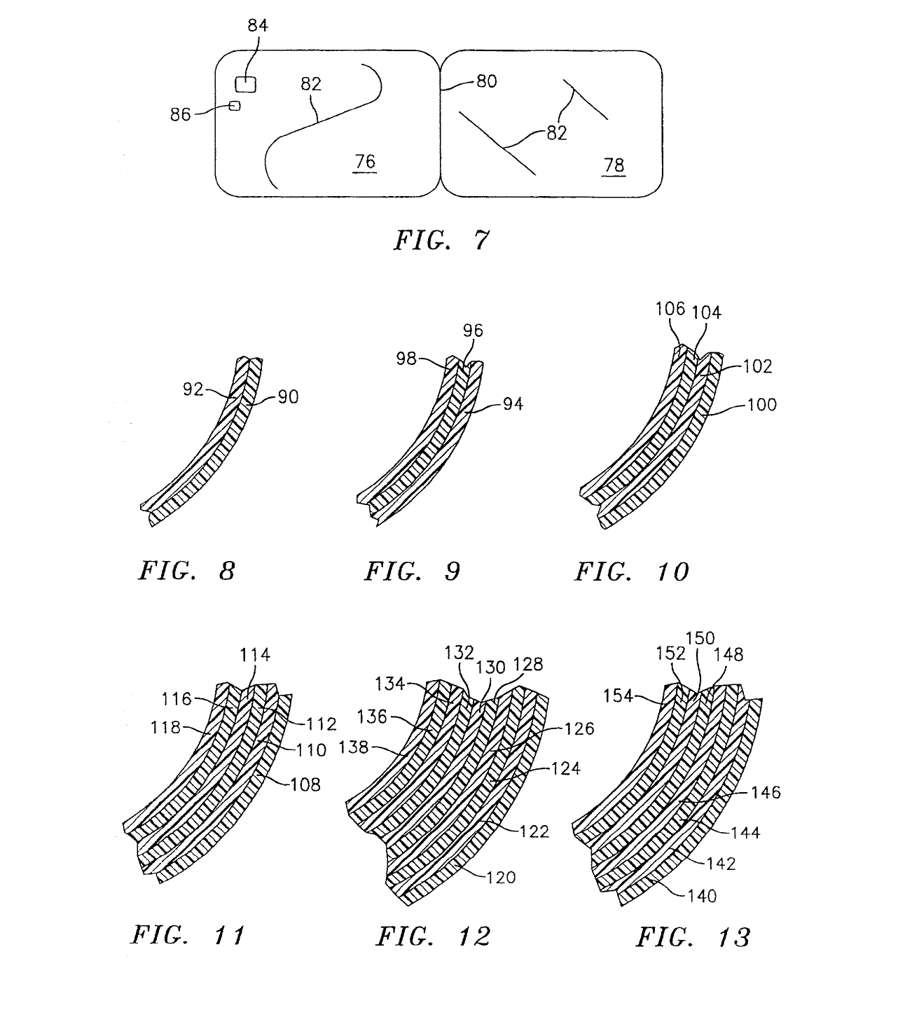

FIG. 7 is a schematic top view of the embodiment of FIG. 6 showing the molded-in hinge 80 of components 76 and 78. In addition, further components may be provided in the fuel tank prior to assembling same. Thus, baffles 82, fuel pump 84 and/or fuel level sensor 86 may be provided within the fuel tank prior to assembly. Alternatively, other desired components may readily be provided within the fuel tank.

FIGS. 8-13 show a variety of different wall structures which may be readily prepared in accordance with the present invention. For example, the present invention contemplates a wide variety of different components for the film layer and for the molding resins. Representative materials are listed below, and these may be combined in any desired and convenient manner.

I. Representative Mono-Layer Films

A. High Density Polyethylene

B. High Density Polyethylene/Tie or Adhesive Layer

C. Polypropylene/Tie or Adhesive Layer

D. Polyamide

II. Representative Multi-Layer Films

A. High Density Polyethylene/Tie or Adhesive Layer/Polyamide

B. Polypropylene/Tie or Adhesive Layer/Polyamide

C. High Density Polyethylene/Tie or Adhesive Layer/Polyamide/Tie or Adhesive Layer/High Density Polyethylene

D. High Density Polyethylene/Tie or Adhesive Layer/EVOH/Tie or Adhesive Layer

E. High Density Polyethylene/Tie or Adhesive Layer/EVOH/Tie or Adhesive Layer/High Density Polyethylene

F. High Density Polyethylene/Tie or Adhesive Layer/EVOH/Tie or Adhesive Layer/Polyamide

III. Representative Molding Resins

A. High Density Polyethylene

B. Polypropylene

C. Polyamide

Thus, referring to FIG. 8, layer 90 is a high density polyethylene film, and layer 92 is a polyamide molding resin, with the film being corona treated to aid in bonding. FIG. 9 shows a high density polyethylene film 94, tie layer or adhesive layer 96 and a polyamide molding resin 98. FIG. 10 shows a multi-layer film including high density polyethylene 100, a tie layer or adhesive layer 102 and a polyamide film layer 104. The molding resin is a polyamide 106.

FIG. 11 also shows a multi-layer film component including high density polyethylene 108, a tie layer or adhesive layer 110, a polyamide film layer 112, a further tie or adhesive layer 114, and a further high density polyethylene film layer 116. The molding resin 118 is high density polyethylene.

FIG. 12 shows a multi-layer film component provided on both sides of the deposited resin. Thus, referring to FIG. 12, the outside film layers include high density polyethylene film 120, a tie layer or adhesive layer 122, an EVOH layer 124, and a further tie or adhesive layer 126. The deposited molding resin is high density polyethylene 128. The opposed or inner side of the assembly includes high density polyethylene film 130, a tie or adhesive layer 132, a polyamide film layer 134, a further tie layer 136 and a further high density polyethylene film layer 138.

The embodiment of FIG. 13 shows multi-layer films on both sides of the deposited resin. Thus, the outside film laminate includes high density polyethylene film 140, a tie or adhesive layer 142, a polyamide film layer 144, a further tie or adhesive layer 146 and a further high density polyethylene film layer 148. The deposited molding resin may be high density polyethylene 150. The inner film may include a tie layer 152 and a polypropylene film 154.

Any desired combination of the foregoing components or others may readily be employed based on desired results. Naturally, FIGS. 8-13 are partly schematic for purposes of illustration and actual thicknesses of the various layers are not to scale. It can be readily seen that a wide variety of different components may readily be prepared to provide a wide variety of different properties depending upon the particular requirements.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A compression molded fuel tank, which comprises: a first and second section, each of which is a laminate of at least two dissimilar materials, wherein said sections are affixed together at peripheral portions thereof to form a closed, hollow member with an internal cavity therein, and including an inlet to said cavity; wherein the laminate of each section includes an outer plastic film layer and an inner plastic layer, and wherein each laminate is a compression molded laminate.

2. A compression molded fuel tank according to claim 1, wherein each section includes a peripheral flange, and wherein said sections are affixed together at said peripheral flanges.

3. A compression molded fuel tank according to claim 1, wherein said compression molded sections include a connecting portion therebetween.

4. A compression molded fuel tank according to claim 1, including at least one baffle within the closed, hollow member.

5. A compression molded fuel tank according to claim 1, including at least one of a fuel pump and a fuel level sensor within the closed, hollow member.

6. A compression molded fuel tank according to claim 1, wherein the film is a mono-layer film.

7. A compression molded fuel tank according to claim 1, wherein the film is a multi-layer film.

8. A compression molded fuel tank according to claim 6, wherein the film is one of high density polyethylene, polypropylene, or polyamide.

9. A compression molded fuel tank according to claim 7, wherein the multi-layer film is one of (1) high density polyethylene-polyamide, (2) polypropylene-polyamide, (3) high density polyethylene-polyamide-high density polyethylene, (4) high density polyethylene-ethylvinyl alcohol, (5) high density polyethylene-ethylvinyl alcohol-high density polyethylene, and (6) high density polyethylene-ethylvinyl alcohol-polyamide.

10. A compression molded fuel tank according to claim 1, including at least two inner plastic layers.

11. A compression molded fuel tank according to claim 1, wherein said inner plastic layer is at least one of high density polyethylene, polypropylene, and polyamide.

12. A compression molded fuel tank according to claim 1, including reinforcing materials in each section.

13. A compression molded fuel tank according to claim 1, including conductive additives to each section to reduce static electricity build-up.

14. A compression molded fuel tank according to claim 1, wherein each section has barrier properties.

15. A compression molded fuel tank according to claim 1, wherein the film has a thickness of from about 0.010 inch to 0.050 inch, and the plastic layer has a thickness of from about 0.050 inch to 0.40 inch.

16. A compression molded fuel tank according to claim 1, including a barrier layer on the plastic layer.

17. A method for forming a compression molded fuel tank, which comprises: compression molding first and second laminates for first and second sections of said fuel tank, each having at least two dissimilar materials, wherein the laminate of each section includes an outer plastic film layer and an inner plastic layer; affixing said sections together at peripheral portions thereof to form a closed hollow member with an internal cavity therein; and forming an inlet to said internal cavity.

18. A method according to claim 17, including affixing said sections together at a peripheral flange of each section.

19. A method according to claim 17, including providing that the film is one of a mono-layer film and a multi-layer film.

20. A method according to claim 12, including providing at least two inner plastic layers.
